(19) United States
(12) Patent Application Publication
(10) Pub. No.: US 2010/0201469 A1
(43) Pub. Date: Aug. 12, 2010

(54) SOFT MAGNETIC MATERIAL AND SYSTEMS THEREWITH

(75) Inventors: Luana Emiliana Iorio, Clifton Park, NY (US); Michael Francis Xavier Gigliotti, Scotia, NY (US); Pazhayannur Ramanathan Subramanian, Niskayuna, NY (US); Francis Johnson, Clifton Park, NY (US); Israel Samson Jacobs, Schenectady, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/710,975

(22) Filed: Feb. 23, 2010

Related U.S. Application Data
(63) Continuation-in-part of application No. 11/501,288, filed on Aug. 9, 2006, now abandoned.

(51) Int. Cl. H01F 1/00; C22C 38/00; C22C 19/07; C22C 38/02; H01F 1/147

(52) U.S. Cl. 335/296; 420/82; 420/8; 420/435; 420/117; 148/311; 148/313

(57) ABSTRACT

A soft magnetic alloy including iron, cobalt, and at least one alloying addition including a platinum group metal, rhenium, or combinations thereof is provided. A device which is formed from such an alloy is also described.

The present application is a Continuation-In-Part of application Ser. No. 11/501,288, filed on Aug. 9, 2006; and claims the benefit of that application.

### BACKGROUND

The invention relates generally to a soft magnetic material. In addition, the invention relates to devices, such as electric motors and generators, utilizing a magnetic material in a rotor or another component in which both magnetization and strength may affect overall performance, longevity, and other factors.

Soft magnetic materials play a key role in a number of applications, especially in electric and electromagnetic devices. There is a growing need for lightweight and compact electric machines. Compact machine designs may be realized through an increase in the rotational speed of the machine. In order to operate at very high speeds, these machines need materials capable of operating at high flux densities. The materials must also exhibit high tensile strength, without structural failure, according to service life requirements. Moreover, the materials must, at the same time, permit relatively low magnetic core losses. Generally, achieving high mechanical strength and superior magnetic performance concurrently is difficult in conventional materials. High strength typically is obtained at the expense of important magnetic properties, such as magnetic saturation and core loss.

### BRIEF DESCRIPTION

Various embodiments of the present invention provide a magnetic material with substantially high yield strength and improved magnetic properties. One aspect of the invention relates to a soft magnetic, crystalline alloy, comprising

(a) iron;

(b) about 15 atomic percent to about 60 atomic percent cobalt; and

(c) about 0.05 atomic percent to about 9.9 atomic percent (total) of at least one platinum group metal, rhenium, or combinations thereof.

A second aspect of the invention is directed to a device. The device is formed in part from the soft, magnetic, crystalline alloy, described herein.

These and other aspects, advantages, and salient features of the present invention will become apparent from the following detailed description, the accompanying drawings, and the appended claims.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an electromagnetic device;

FIG. 2 is a plot of saturation magnetization versus Vickers hardness for Fe—Co alloys with various elemental additions in accordance with embodiments of the present technique; and

FIG. 3 is a plot of coercivity versus Vickers hardness for Fe—Co alloys with various elemental additions in accordance with embodiments of the present technique.

### DETAILED DESCRIPTION

The compositional ranges disclosed herein are inclusive and combinable (e.g., ranges of “up to about 25 wt %”, or, more specifically, “about 5 wt % to about 20 wt %”, are inclusive of the endpoints and all intermediate values of the ranges). Moreover, the term “combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity). Moreover, in this specification, the suffix “(s)” is usually intended to include both the singular and the plural of the term that it modifies, thereby including one or more of that term (e.g., “the compound” may include one or more compounds, unless otherwise specified). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

For many electrical devices and components in a variety of applications, including aerospace, wind power and electric vehicles, magnetic materials with high permeability, high saturation magnetization, low core loss, and high mechanical strength are attractive. There is a continuing need for magnetic materials with improved magnetic properties and high mechanical strength. Disclosed herein is a soft magnetic alloy having substantially high yield strength, and superior magnetic properties. In accordance with certain embodiments, certain materials (i.e., alloying additives) may be added to an iron-cobalt (Fe—Co) alloy in suitable quantities to enhance the mechanical strength, and saturation magnetization, and not significantly adversely affect coercivity to obtain high strength, high ductility, high saturation magnetization, and low coercivity magnetic materials. The details of the alloy compositions are described in the subsequent embodiments.

As discussed in detail below, the soft magnetic materials may include an iron-cobalt-alloy composition. For these alloys, the level of cobalt (Co) is usually in the range of about 15 atomic percent to about 60 atomic percent, or about 20 atomic percent to about 35 atomic percent, or about 45 atomic percent to about 55 atomic percent, or about 25 atomic percent to about 32 atomic percent (These levels are based on the entire atomic weight of the alloy, with the understanding that the total amount of cobalt, iron, and other constituents cannot exceed 100 atomic percent).

As mentioned previously, the soft magnetic materials further comprise at least one platinum group metal, rhenium, or combinations thereof, in the range of about less than 10 atomic percent (e.g., 9.9 atomic percent or less); less than about 5 atomic percent (e.g., 4.9 atomic percent or less); less than 2 atomic percent; or between about 0.05 and about 2 atomic percent. (These levels are based on the atomic weight of the entire material, wherein it is understood that the Pt-group/Re elements could substitute for Co or iron (Fe), or for both Co and Fe). Examples of the platinum group metals are platinum, palladium, iridium, ruthenium, rhodium, osmium, or combinations thereof (i.e., a combination of at least two of the elements). In certain embodiments, these alloying additions may result in magnetization of greater than about 1.8 Tesla, coercivity of less than about 100 Oersteds, and yield strength of greater than about 700 MegaPascals.

The level of iron (Fe) for the alloys described herein is usually in the range of about 40 atomic percent to about 85 atomic percent, based on the atomic weight of the entire alloy material, and in some instances, in the range of about 65 atomic percent to about 80 atomic percent. In some specific embodiments, e.g., where the power loss of the device must be very low, the level of Fe is often in the range of about 45 atomic percent to about 55 atomic percent. In other preferred embodiments in which the alloy must exhibit very high saturation magnetization, the level of Fe is often in the range of about 68 atomic percent to about 75 atomic percent.

The alloys of the present invention have a crystalline structure, and are substantially free of any amorphous structure. Thus, while the alloys are still formed of soft magnetic materials, which provide excellent molding and processing properties, the crystalline structure provides the enhanced magnetic properties (e.g., saturation magnetization), while also providing the strength needed for very rigorous end use applications. In general, the alloys are characterized by an A2 or B2 crystal structure. In most embodiments, at least about 95% of the detectable phases are characterized by these crystal phases (individually or in combination). In some embodiments, at least about 98% of the detectable phases and A2 and/or B2. (Examples of other phases which sometimes constitute the remainder of the alloy structure are oxide phases and/or carbide phases).

Embodiments of this invention contemplate the use of a number of additional elements to obtain or enhance certain properties. However, the presence of certain elements (or their presence at certain levels) can sometimes be detrimental to the overall properties of the magnetic alloys. For example, the presence of copper can often reduce the saturation magnetization of the alloy. Copper can also increase its magnetic coercivity. The undesirable increase in coercivity may result in a power loss (energy loss) when these soft alloys are employed within an AC circuit, e.g., when used as transformers, rotors, or stators. Thus, in some preferred embodiments of the present invention, the alloy composition is substantially free of copper, e.g., with an amount of copper less than about 0.1 atomic percent, and preferably, less than about 1 ppm.

Moreover, while silicon may sometimes be employed at certain levels in the alloys, its presence can also decrease saturation magnetization. Thus, in some instances, the alloys described herein contain less than about 4 atomic percent silicon; and more specifically, less than about 2 atomic percent silicon. In other embodiments, the alloys are substantially free of silicon. For similar reasons, if boron is employed, these magnetic alloys contain less than about 4 atomic percent boron; and more specifically, less than about 2 atomic percent boron. In some embodiments, the magnetic alloys described herein are substantially free of boron.

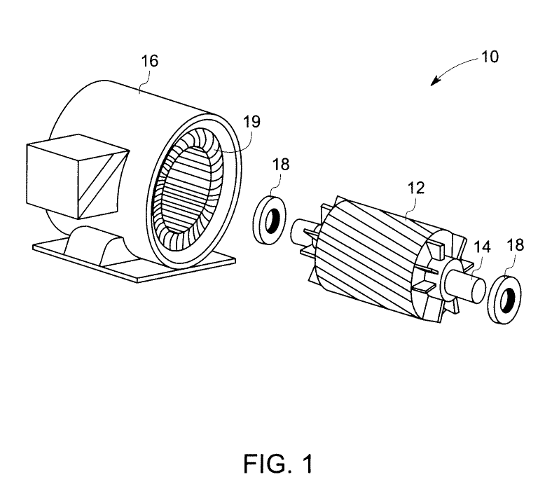

FIG. 1 is a diagrammatical perspective illustration of an electrical machine, 10. FIG. 1 is provided for illustrative purposes only, and the present invention is not limited to any specific electrical machine or configuration thereof. In the illustrated example, the machine 10 includes a rotor assembly 12, which includes a rotor shaft 14 extending through a rotor core. The rotor assembly 12 along with the shaft 14 can rotate inside the stator assembly 16 in a clockwise or a counter-clockwise direction. Bearing assemblies 18 that surround the rotor shaft 14 may facilitate such rotation within the stator assembly 16. The stator assembly 16 includes a plurality of stator windings that extend circumferentially around and axially along the rotor shaft 14, through the stator assembly 16. During operation, rotation of the rotor assembly 12 causes a changing magnetic field to occur within the machine 10. This changing magnetic field induces voltage in the stator windings 19. Thus, the kinetic energy of the rotor assembly 12 is converted into electrical energy, in the form of electric current and voltage in the stator windings 19. Alternately, the machine 10 may be used as a motor, wherein the induced current in the rotor assembly 12 reacts with a rotating magnetic field to cause the rotor assembly 12 to rotate. In some embodiments, the motor is a synchronous motor, and in other embodiments, the motor is an asynchronous motor. Synchronous motors rotate at exactly the source frequency scaled up by the pole pair count, while asynchronous motors exhibit a slower frequency characterized by the presence of slip. One skilled in the art would know how to implement changes in the design, as per the requirement of the device.

One or more of the rotor assembly 12, or the stator assembly 16, of the machine 10 may include soft magnetic alloys of the disclosed embodiments. Superior magnetic and mechanical properties of the soft magnetic alloys of the disclosed embodiments provide distinct advantages in terms of the performance of the machine. The specific composition of the alloy and its magnetic and mechanical property characterization are described in greater detail below. In the examples described herein, the machine 10 is a radial type machine where the flux flows radially through the air gap between the rotor and the stator. However, other examples of the machine 10 may operate with axial flux flow as well, where the flux flows parallel to the axis of the machine 10. Though the operation of the machine 10 is explained with a simple diagram, examples of the machine 10 are not limited to this particular simple design. Other more complicated designs are also applicable, and may benefit from the soft magnetic materials discussed in detail below.

In certain embodiments, the soft magnetic alloy comprises iron, cobalt, and at least one alloying addition including a platinum group metal, rhenium, or combinations thereof. In one embodiment, cobalt is present in the alloy in the range of from about 15 atomic percent to about 60 atomic percent. In another embodiment, the alloy comprises cobalt in the range of from about 45 atomic percent to about 55 atomic percent. In one embodiment, the alloy comprises cobalt in the range of from about 20 atomic percent to about 35 atomic percent. The amount of cobalt may be chosen to optimize the magnetic properties of the alloy, reduce the material cost, and enhance the material processibility.

The magnetic and the mechanical properties of the alloys may be controlled by controlling the amount of alloying addition introduced. The soft magnetic alloy comprises at least one alloying addition including at least one platinum group metal (and/or rhenium), wherein the at least one platinum group metal comprises platinum, or palladium, or iridium, or ruthenium, or rhodium, or osmium, or combinations thereof. Introduction of these additions is expected to increase the yield strength of the alloy. However, the amount of the alloying addition may need to be controlled so as to limit the precipitation of intermetallic compounds, which may adversely affect the magnetic properties of the alloy. Therefore an optimum amount of alloying addition is introduced. In one embodiment, the soft magnetic alloy comprises the alloying addition (total) in an amount less than about 10 atomic percent, or less than about 5 atomic percent. In one embodiment, the device includes alloying additions in the range of from about 0.05 atomic percent to about 2 atomic percent. In another embodiment, the soft magnetic alloy comprises alloying additions in an amount in the range of from about 0.05 atomic percent to about 1 atomic percent.

In an exemplary embodiment, the alloy comprises palladium in the amount of less than about 3 atomic percent, e.g., about 0.1 atomic percent to about 2.9 atomic percent. In another exemplary embodiment, the alloy comprises palladium in the amount of less than about 1.5 atomic percent. In one exemplary embodiment, the soft magnetic alloy comprises ruthenium at a level less than about 3 atomic percent, e.g., about 0.1 atomic percent to about 2.9 atomic percent. In another exemplary embodiment, the soft magnetic alloy comprises ruthenium at a level less than about 1.5 atomic percent, e.g., about 0.1 atomic percent to about 1.4 atomic percent. In another exemplary embodiment, the soft magnetic alloy comprises rhenium at a level less than about 3 atomic percent, e.g., about 0.1 atomic percent to about 2.9 atomic percent. In another exemplary embodiment, the soft magnetic alloy comprises rhenium at a level less than about 1.9 atomic percent, e.g., about 0.1 atomic percent to about 1.8 atomic percent.

Alloying additions may be introduced into the Fe—Co baseline alloy by a number of techniques. In some embodiments, the constituent materials are melted together and processed to obtain an alloy of desired composition. One example of such a process is vacuum induction melting. In another embodiment, all the constituent materials are subjected to mechanical alloying to obtain the alloy of desired composition.

Additional elements may be present in controlled amounts to benefit other desirable properties provided by this alloy. The amount of these additions is selected so as not to hinder the magnetic performance of the alloy. In addition, the alloy may also comprise usual impurities found in commercial grades of alloys intended for similar service or use. The levels of such impurities are controlled so as not to adversely affect the desired properties.

The alloys of the invention desirably exhibit high saturation magnetization, low coercivity, and high mechanical strength. In one embodiment, the soft magnetic material has a saturation magnetization of at least about 1.8 Tesla. In another embodiment, the magnetic material has a saturation magnetization at least about 2 Tesla. In one embodiment, the magnetic material has a coercivity of less than about 100 Oersteds. In another embodiment, the soft magnetic material has a coercivity of less than about 50 Oersteds. The high saturation magnetization values allow the soft magnetic material to be operated at very high flux densities, enabling compact electric machine designs. In one embodiment, the soft magnetic material of the disclosed embodiments has a yield strength of greater than about 500 MPa. In another embodiment, the magnetic material has a yield strength of greater than about 700 MPa.

In one embodiment, a system includes a device having one or more components formed of a soft magnetic alloy. For example, the soft magnetic alloy can include iron, cobalt, and at least one alloying addition including a platinum group metal, rhenium, or combinations thereof. The composition of the soft magnetic alloy may be chosen, based on the desired properties for the specific application of the device, and is similar to those described in above embodiments. Examples of the system include a generator, a motor, an alternator, or a combination thereof. In an exemplary embodiment, the device comprises a rotor of an electrical machine. In another embodiment, the device comprises a stator of an electrical machine.

Non-limiting examples of the electrical machine include a generator, a motor, and an alternator. In other embodiments, the system comprises a magnetic bearing, an electromagnet pole piece for high field magnets, an actuator, an armature, a solenoid, an ignition core, or a transformer. As known to those skilled in the art of electrical machines, stator and rotor designs vary based on application, and may include one or more magnetic components. Certain embodiments of the disclosed soft magnetic materials provide performance and/or efficiency improvements for aerospace applications, due to the higher yield strength, lower magnetic core losses, and the ability to operate at relatively higher flux densities than previous magnetic alloys. In other embodiments, the soft magnetic material is incorporated into components of a machine in an electric or a hybrid vehicle, in a bearing assembly, or a wind power system.

The soft magnetic alloy of the disclosed embodiments is suitable for many electromagnetic device applications. They are especially attractive for devices comprising these alloys in a bulk monolithic structure form, or for devices which have components made from a bulk structure, e.g., relatively large and thick ingots which are forged into billets, as described below. These alloys may be easily processed with suitable mechanical and magnetic properties in a bulk structure form.

Accordingly, in some embodiments, the device comprises a bulk monolithic structure of the alloy. The alloy comprising the device may be in the form of a sheet, a plate, or a bar. The bulk monolithic structure often has a thickness (in at least one dimension) of at least about 100 micrometers, and in some specific embodiments, at least about 200 micrometers. In another embodiment, the bulk monolithic structure has a thickness in the range of from about 200 micrometers to about 200 millimeters. In other embodiments, the thickness of the bulk monolithic structure is in the range of about 200 millimeters to about 400 millimeters, and in some preferred embodiments, greater than about 400 millimeters. In contrast, some of the magnetic alloys which have been used previously in electrical and power applications cannot readily be prepared, if at all, in relatively large thicknesses.

A sheet of the alloy may be prepared by any suitable metallurgical process including, casting, forging, extrusion, hot rolling, or cold rolling. The alloy may additionally be prepared by powder metallurgical processing. The powder may be made into a consolidated bulk structure by any known consolidation technique, including hot pressing, hot isostatic pressing, blind-die compaction and extrusion, or the like. Alloys may be formed into sheets having an insulating coating thereon, and overlapping the coated sheets, to form a laminated article, such as a stator or rotor of an electric machine.

The soft magnetic alloys of the embodiments may be prepared, worked, and formed into products using any suitable conventional technique known in the art. The alloys may be melted in air as by means of an electric arc furnace, or may be melted using suitable vacuum melting techniques, such as vacuum induction melting (VIM) and/or vacuum arc remelting (VAR). After being melted and cast as an ingot, the alloy may be forged into billets or slabs. The alloy product may be hot rolled to strip, and be formed into a coil while still hot. The thus-formed strip is an intermediate product substantially thicker than the finished size. The finished size may then be formed by cold rolling the strip to the desired thickness or gauge.

The following example serves to illustrate the features and advantages offered by the embodiments of the present invention, and is not intended to limit the invention thereto.

### Example

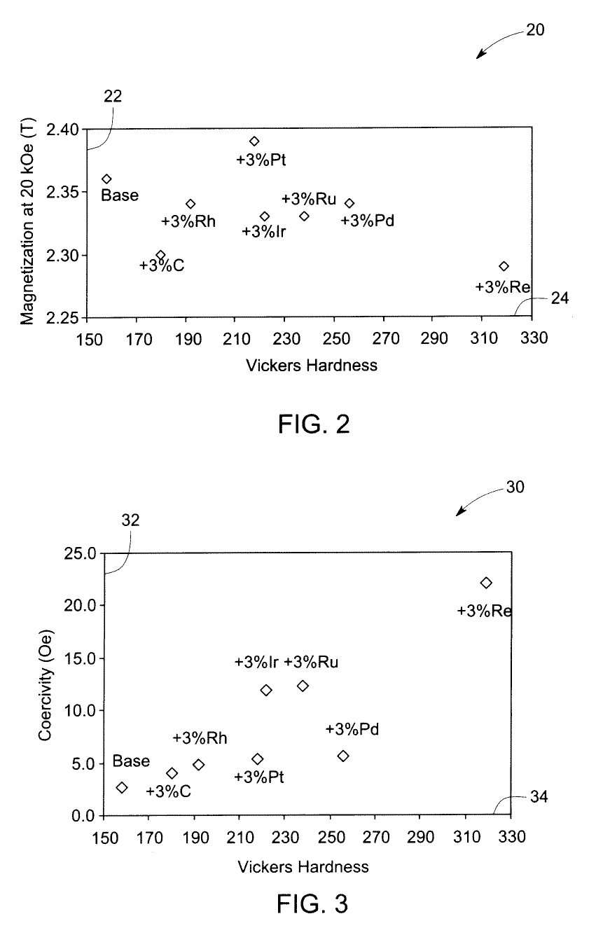

Alloys with different alloying additions were vacuum induction melted and poured into a copper mold to produce 25 mm bars approximately 120 mm in length. The alloys comprised a base Fe—Co composition (with 30 atomic percent Co), then compositions to which 1.8 and 3 atomic percent of individual elements were added. The cast samples were then hot isostatically pressed at 950° C. for 4 hours at 205 MPa. Vickers hardness measurements were made on each of the alloys. The hardness values are used as an indicator of the mechanical strength of the alloys. Room temperature dc magnetic properties of each alloy were measured by vibrating sample magnetometry. High energy X-ray diffraction was used to measure the lattice parameters of each alloy and thus enable a calculation of the alloy density. The results are tabulated in Table 1 and shown in FIGS. 2 and 3. It is clear that all of the alloying additions provided significant hardness improvement over a baseline Fe—Co alloy, and over an alloy with a carbon addition. Ru, Pd, and Re additions provided particularly large hardness increases.

TABLE 1

| | Vickers hardness | Coercivity | Magnetization at |
|---|---|---|---|
| Composition (at %) | (Hv) | (Oe) | 20 kOe (T) |
| Fe—30Co (baseline) | 158 | 2.7 | 2.36 |
| Fe—30Co—3C | 180 | 4.0 | 2.30 |
| Fe—30 Co—3Rh | 192 | 4.8 | 2.34 |
| Fe—30 Co—3Pt | 218 | 5.3 | 2.39 |
| Fe—30 Co—3Ir | 222 | 11.9 | 2.33 |
| Fe—30 Co—3Ru | 238 | 12.3 | 2.33 |
| Fe—30 Co—3Pd | 256 | 5.6 | 2.34 |
| Fe—30 Co—1.8Re | 305 | 16.9 | 2.22* |
| Fe—30 Co—3Re | 319 | 22.0 | 2.29 |

*May be underestimate due to presence of porosity in this sample

FIG. 2 is a plot 20 of magnetization at 20 kOe plotted along Y-axis (22) versus Vickers hardness plotted along X-axis (24) for the Fe—Co alloys. All of the saturation magnetization values exceed 2.2 T and are comparable with the baseline Fe—Co alloy.

FIG. 3 shows plot (30) of coercivity plotted along Y-axis (32) versus Vickers hardness plotted along X-axis (34) for Fe—Co alloys. From plot 30, it is clear that Pt and Pd additions provided particularly large hardness increases and low coercivity values.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A soft magnetic, crystalline alloy, comprising
(a) iron;
(b) about 15 atomic percent to about 60 atomic percent cobalt; and
(c) about 0.05 atomic percent to about 9.9 atomic percent (total) of at least one platinum group metal, rhenium, or combinations thereof.

2. The soft magnetic alloy of claim 1, wherein the soft magnetic alloy comprises cobalt in the range of from about 20 atomic percent to about 35 atomic percent.

3. The soft magnetic alloy of claim 1, wherein the soft magnetic alloy comprises cobalt in the range of from about 45 atomic percent to about 55 atomic percent.

4. The soft magnetic alloy of claim 1, wherein the platinum group metal comprises platinum, palladium, iridium, ruthenium, rhodium, osmium, or a combination thereof.

5. The soft magnetic alloy of claim 1, wherein component (c) is present in the range of about 0.05 atomic percent to about 4.9 atomic percent.

6. The soft magnetic alloy of claim 1, wherein the platinum group metal of component (c) comprises platinum, palladium, or combinations thereof.

7. The soft magnetic alloy of claim 1, wherein component (c) comprises palladium, ruthenium, and rhenium, or combinations thereof.

8. The soft magnetic alloy of claim 7, wherein the level of component (c) (total) is in the range of about 0.05 atomic percent to about 4.9 atomic percent.

9. The soft magnetic alloy of claim 1, substantially free of copper.

10. The soft magnetic alloy of claim 1, comprising silicon in an amount of less than about 4 atomic percent.

11. The soft magnetic alloy of claim 1, having a saturation magnetization of at least about 1.8 Tesla.

12. The soft magnetic alloy of claim 1, having a coercivity of less than about 100 Oersteds.

13. A soft magnetic, crystalline alloy, consisting essentially of:
(i) iron;
(ii) about 15 atomic percent to about 60 atomic percent cobalt; and
(iii) about 0.05 atomic percent to about 9.9 atomic percent (total) of at least one platinum group metal, rhenium, or combinations thereof.

14. A device, comprising a soft, magnetic, crystalline alloy, which itself comprises:
(a) iron;
(b) about 15 atomic percent to about 60 atomic percent cobalt; and
(c) about 0.05 atomic percent to about 9.9 atomic percent (total) of at least one platinum group metal, rhenium, or combinations thereof.

15. The device of claim 14, wherein the alloy comprises a bulk monolithic structure, having a thickness of at least about 100 micrometers.

16. The device of claim 14, in the form of an electric or electromagnetic machine.

17. The device of claim 14, in the form of a generator, motor, alternator, or a combination thereof.

18. The device of claim 14, in the form of a rotor or a stator.

19. The device of claim 14, comprising a magnetic bearing, an electromagnet pole piece, an actuator, an armature, a solenoid, an ignition core, or a transformer.

20. The device of claim 16, incorporated into a hybrid vehicle, a bearing assembly, or a wind power system.
